(19) United States
(12) Patent Application Publication
(10) Pub. No.: US 2023/0229196 A1
(43) Pub. Date: Jul. 20, 2023

(54) DISPLAY MODULE AND DISPLAY DEVICE

(71) Applicants: MIANYANG BOE OPTOELECTRONICS TECHNOLOGY CO., LTD., Sichuan (CN); BOE TECHNOLOGY GROUP CO., LTD., Beijing (CN)

(72) Inventors: Ming Li, Beijing (CN); Lin Xiong, Beijing (CN); Yuliang Wang, Beijing (CN); Jun Wang, Beijing (CN); Xu Zhao, Beijing (CN); Shenghua Bai, Beijing (CN); Jie Li, Beijing (CN); Xing Zou, Beijing (CN); Fanyou Li, Beijing (CN); Mu Zeng, Beijing (CN); Chao Liu, Beijing (CN); Miao Wang, Beijing (CN); Jie Tu, Beijing (CN); Zhoujun Chen, Beijing (CN); Guifang He, Beijing (CN); Chunrong Lai, Beijing (CN)

(73) Assignees: MIANYANG BOE OPTOELECTRONICS TECHNOLOGY CO., LTD., Sichuan (CN); BOE TECHNOLOGY GROUP CO., LTD., Beijing (CN)

(21) Appl. No.: 17/924,526

(22) PCT Filed: May 12, 2021
(86) PCT No.: PCT/CN2021/093387

§ 371 Date: Nov. 10, 2022

(30) Foreign Application Priority Data
Jun. 30, 2020 (CN) 202010617140.9

(51) Int. Cl. G06F 1/16

(52) U.S. Cl. CPC G06F 1/1656; G06F 1/1616

(57) ABSTRACT

The display module (100) includes: a supporting member (2) and a display panel (2), supporting member (1) includes an interlayer part (11) and a supporting part (12), the surface of the side of the supporting part (12) that is away from the interlayer part (11) is a supporting curved face (121), the supporting curved face (121) protrudes in the direction away from the interlayer part (11), the display panel (2) includes a non-bending part (21), a bending part (22) and a connecting part (23), the non-bending part (21) and the connecting part (23) are located on the two sides of the interlayer part (11) in the thickness direction of the interlayer part (11), the bending part (22) supports the side of the supporting part (12) that is away from the interlayer part (11), and the inner surface of the bending part (22) adheres to the supporting curved face (121).

### CROSS REFERENCE TO RELEVANT APPLICATIONS

The present application is filed on the basis of and claims the priority of the Chinese patent application filed on June 30^{th}, 2020 with the application number of 202010617140.9, which is incorporated herein in its entirety by reference.

### TECHNICAL FIELD

The present application relates to the technical field of displaying and, more particularly, to a display module and a display device.

### BACKGROUND

In the technical field of OLEDs (the abbreviation for Organic Light Emitting Diode), in the bending process of some display panels, it is difficult to ensure bending to the ideal appearance according to the designed path, and dart easily happens. Furthermore, after the bending of the display panels, the bending area easily depresses due to force bearing, which affects the product quality, and even results in product failure.

### SUMMARY

The present application aims at solving at least one of the technical problems in the prior art. In view of the above, the present application provides a display module, wherein in the display module, a supporting part is used to ensure the bending path of a bending part, and serve to reliably support and protect the bending part, which reduces the difficulty in the processing, increases the processing efficiency, and improves the product quality.

The present application further provides a display device having the display module stated above.

A display module according to an embodiment of the first aspect of the present application includes:
a supporting member, wherein the supporting member includes an interlayer part and a supporting part, the supporting part is connected to a side edge of the interlayer part, a surface of one side of the supporting part that is away from the interlayer part is a supporting curved face, and the supporting curved face protrudes in a direction away from the interlayer part; and
a display panel, wherein the display panel includes a non-bending part, a bending part and a connecting part, the bending part connects the non-bending part and the connecting part, and after the display panel has been bent, the non-bending part and the connecting part are located on two sides of the interlayer part in a thickness direction of the interlayer part, the bending part supports one side of the supporting part that is away from the interlayer part, and an inner surface of the bending part adheres to the supporting curved face.

In the display module according to the embodiments of the present application, the supporting part is used to ensure the bending path of the bending part, and serve to reliably support and protect the bending part, which reduces the difficulty in the processing, increases the processing efficiency, and improves the product quality.

In some embodiments, the thickness direction of the interlayer part is a first direction, and a height H2 of the supporting part in the first direction is greater than a thickness H1 of the interlayer part.

In some embodiments, one end among two ends in the first direction of the supporting part that is close to the non-bending part is a first end, one end that is close to the connecting part is a second end, a surface of one side of surfaces of two sides in the thickness direction of the interlayer part that is close to the non-bending part is a first surface, a surface of one side that is close to the connecting part is a second surface, and in the first direction, the first surface is located on one side of the first end that is close to the second end, and the second surface is located on one side of the second end that is close to the first end.

In some embodiments, in the first direction, a distance H4 between the first surface and the first end is greater than a distance H3 between the second surface and the second end.

In some embodiments, a surface of the first end is a smooth curved face, and a surface of the second end is a smooth curved face.

In some embodiments, the interlayer part includes a setting side edge extending in a second direction, the supporting part is connected to the setting side edge, and the supporting part also extends in the second direction.

In some embodiments, two ends of the supporting part in the second direction align with two ends of the setting side edge in the second direction.

In some embodiments, the supporting curved face is a circular-arc cylindrical face.

In some embodiments, the supporting part is of a semi-cylinder shape, and the interlayer part is of a shape of a constant-thickness flat-plate.

In some embodiments, adhesive layers are disposed on two sides of the interlayer part in the thickness direction of the interlayer part.

A display device according to an embodiment in the second aspect of the present application includes the display module according to the embodiment in the first aspect of the present application.

The display device according to the embodiments of the present application, by disposing the above display module in the first aspect, improves the overall performance of the display device.

Some of the additional aspects and advantages of the present application will be given in the following description, and some will become apparent from the following description or be known from the implementation of the present application.

### BRIEF DESCRIPTION OF THE DRAWINGS

FIG. 1 is a sectional view of a display module according to an embodiment in the related art;

FIG. 2 is a perspective view of the spacer shown in FIG. 1;

FIG. 3 is a sectional view of a display module according to an embodiment of the present application, wherein the display panel in the figure is in a non-bending state;

FIG. 4 is a state diagram of the display panel shown in FIG. 3 after it has been bent;

FIG. 5 is a sectional view of the supporting member shown in FIG. 4;

FIG. 6 is a perspective view of the supporting member shown in FIG. 5;

FIG. 7 is a schematic diagram of a display device according to an embodiment of the present application;

FIG. 8 is a sectional view of a display module according to another embodiment of the present application, wherein the display panel in the figure is in a non-bending state; and

FIG. 9 is a sectional view of a supporting member according to another embodiment of the present application.

### REFERENCE NUMBERS

display panel A1; protecting adhesive A2; spacer A3; hollow area A4; bending-area circular arc A5;
display device 1000; display module 100; first direction F1; second direction F2;
supporting member 1; interlayer part 11; setting side edge 111; first surface 112; second surface 113;
supporting part 12; supporting curved face 121; first end 122; second end 123;
first connecting face 124; second connecting face 125;
first transition curved face 126; second transition curved face 127;
first extended plane 128; second extended plane 129;
adhesive layers 13;
display panel 2; non-bending part 21; bending part 22; connecting part 23;
protecting layer 3; heat dissipating layer 4; first bottom layer C; second bottom layer D;
protecting adhesive 6; Flip-Chip thin film 7; and flexible circuit board 8.

### DETAILED DESCRIPTION

The embodiments of the present application will be described in detail below, and the examples of the embodiments are illustrated in the drawings, wherein the same or similar reference numbers throughout the drawings indicate the same or similar elements or elements having the same or similar functions. The embodiments described below with reference to the drawings are exemplary, are intended to interpret the present application, and should not be construed as a limitation on the present application.

The disclosure below provides many different embodiments or examples for the implementation of different configurations of the present application. In order to simplify the disclosure of the present application, components and configurations of specific examples will be described below. Certainly, they are merely examples, and are not intended to limit the present application. Furthermore, the present application may repeat the reference numbers and/or letters in the different examples. Such repeating is for the purpose of simplification and clarity, and it does not indicate the relation between the various discussed embodiments and/or configurations.

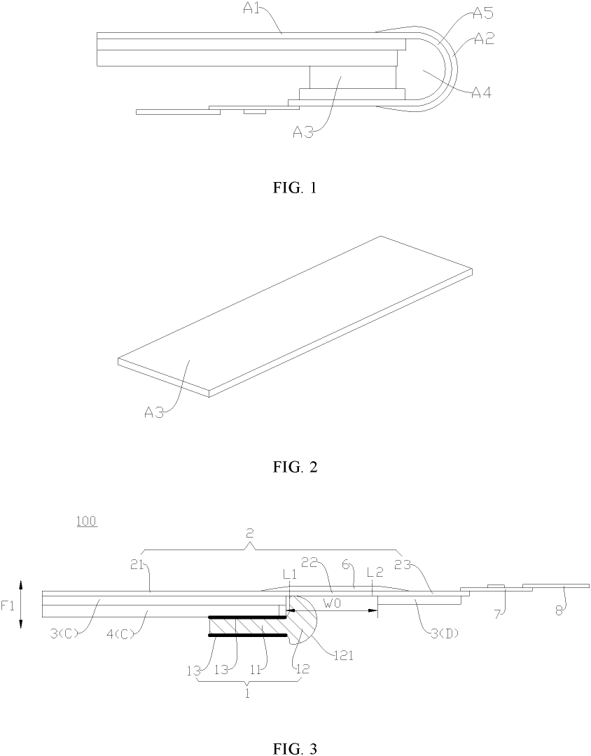

In the technical field of OLEDs (the abbreviation for Organic Light Emitting Diode), in the bending process of some display panels A1, firstly a protecting adhesive A2 (i.e., shadowless glue, also referred to as ultraviolet-light-solidified adhesive, whose thickness is determined according to the elasticity modulus of the ultraviolet-light-solidified adhesive and the lamination thickness of the product, and is generally, for example, 90 µm) is coated to the bending area of the display panel A1, so as to, during the bending, ensure that the property of the stress of the circuit layer of the product is a neutral layer or a compressive stress, to protect the bending area of the display panel A1. Subsequently, a spacer A3 (i.e., Foam, which is usually a PET (the abbreviation for Polyethylene Terephthalate) matrix and has acrylic adhesive material on the two surfaces) is adhered to the back side of the display panel A1. Subsequently, the display panel A1 undergoes bending pre-pressing and main pressing, to reach the appearance shown in FIG. 1. The inventor has found that, because the spacer A3 in the related art is of the shape of the flat plate shown in FIG. 2, after the bending has been completed, the bending area of the display panel A1 is, after the bending, in a hollow support-less state; for example, in FIG. 1 the hollow area A4 does not have a support. When an external force is applied, the bending-area circular arc A5 of the display panel A1 easily depresses, which results in product failure. Furthermore, if the bending-area circular arc A5 of the display panel A1 has an abnormal appearance, that results in cracking of the Data lines within the bending area, and bright lines emerge.

Furthermore, the inventor has further found that, in the whole process of the bending, in order to prevent forced pulling on the display panel A1, an external attracting device is required to attract the display panel A1 throughout the process, and the display panel A1 is required to be bent with a preset involute path into the designed appearance. Because the process of controlling the display panel A1 to be bent with the predetermined involute path has a high difficulty, it is very difficult to ensure that the radius and the appearance of the display panel A1 after the bending satisfy the design requirements, and dart easily happens in the bending process. Especially in the climbing transition area of the protecting adhesive A2 from 0 to 90 µm, the probability of dart is higher.

In order to solve at least one of the above technical problems, the present application provides a display module 100 and a display device 1000 having the display module 100.

A display module 100 according to an embodiment of the present application will be described below with reference to the drawings.

As shown in FIG. 3, the display module 100 may include: a supporting member 1 and a display panel 2. The display panel 2 includes a non-bending part 21, a bending part 22 and a connecting part 23. The bending part 22 connects the non-bending part 21 and the connecting part 23; in other words, the edges of the two sides of the bending part 22 are connected to the non-bending part 21 and the connecting part 23. For example, the part on the left of the dotted line L1 shown in FIG. 3 is the non-bending part 21, the part between the dotted line L1 and the dotted line L2 is the bending part 22, and the part on the right of the dotted line L2 is the connecting part 23. The supporting member 1 includes an interlayer part 11 and a supporting part 12, the supporting part 12 is connected to the side edge of the interlayer part 11, the surface of the side of the supporting part 12 that is away from the interlayer part 11 is a supporting curved face 121, and the supporting curved face 121 protrudes in the direction away from the interlayer part 11.

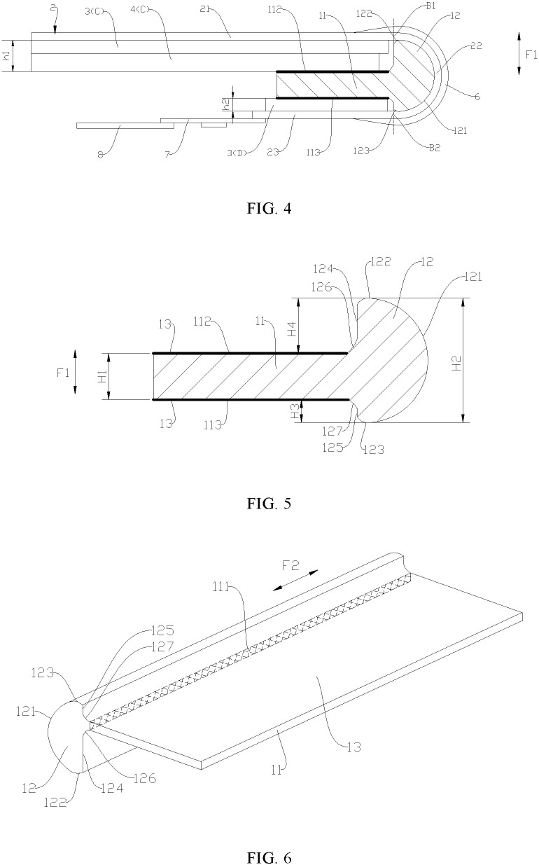

Referring to FIG. 4, after the display panel 2 has been bent, the non-bending part 21 and the connecting part 23 are located on the two sides of the interlayer part 11 in the thickness direction of the interlayer part 11, the bending part 22 supports the side of the supporting part 12 that is away from the interlayer part 11, and the inner surface of the bending part 22 adheres to the supporting curved face 121. In other words, after bent, the connecting part 23 is turned over to the side of the interlayer part 11 that is away from the non-bending part 21; in other words, the non-bending part 21 is located on the displaying side of the interlayer part 11 (for example, the upper side of the interlayer part 11 shown in FIG. 4), and the connecting part 23 is located on the non-displaying side of the interlayer part 11 (for example, the lower side of the interlayer part 11 shown in FIG. 4), thereby supporting the non-bending part 21 and the connecting part 23 by using the interlayer part 11, to avoid cracking of the bending part 22.

Furthermore, by disposing the supporting part 12, and configuring the appearance of the supporting part 12, to enable it to have the supporting curved face 121, during the bending of the display panel 2, the supporting curved face 121 may be used to adhere to the inner surface of the bending part 22, which simply and effectively ensures that the shape of the bending part 22 after the bending satisfies the designing requirement, to prevent cracking of the Data line caused by abnormality of the appearance of the bending part 22, thereby preventing the problem of bright lines. Furthermore, after bent, the bending part 22 may be supported by the supporting part 12, whereby the supporting part 12 serves to support and protect the bending part 22, to prevent depressing of the bending part 22 under an external force, which improves the product quality, and reduces the risk in failure of the product.

In conclusion, in the display module 100 according to the embodiments of the present application, during the bending of the display panel 2, the bending path and the bending radius are not required to be ensured by means of a complicated program setting of the equipment, and are merely required to be realized by the designing of the appearance of the supporting part 12; in other words, in that process, it is merely required to control the design size of the supporting part 12, thereby greatly reducing the difficulty in the processing, and increasing the processing yield. Furthermore, by supporting the bending part 22 by the supporting part 12, the risk in deformation of the bending part 22 is reduced. In other words, in the display module 100 according to the embodiments of the present application, the supporting part 12 is used to ensure the bending path of the bending part 22, and serve to reliably support and protect the bending part 22, which reduces the difficulty in the processing, increases the processing efficiency, and improves the product quality.

In some embodiments of the present application, as shown in FIG. 4, after the display panel 2 has been bent, the connection between the non-bending part 21 and the bending part 22 (for example, the position B1 shown in FIG. 4) has a smooth transition, and the connection between the bending part 22 and the connecting part 23 (for example, the position B2 shown in FIG. 4) has a smooth transition. For example, when the non-bending part 21 and the connecting part 23 are parallel to each other, the distance between the non-bending part 21 and the connecting part 23 is equal to the height H2 of the supporting part 12 in the first direction F1 (referring to FIG. 5). Accordingly, the display panel 2 may be more effectively protected, to prevent damages, cracks and so on of the display panel 2 adjacent to the bent.

In some embodiments of the present application, as shown in FIGS. 4 and 5, the thickness direction of the interlayer part 11 is a first direction F1, and the height H2 of the supporting part 12 in the first direction F1 is greater than a thickness H1 of the interlayer part 11. Accordingly, at least one first bottom layer C may be disposed between the non-bending part 21 and the interlayer part 11, for example, the protecting layer 3 (i.e., B/F) and the heat dissipating layer 4 (i.e., SCF, which does not only serve to dissipate heat, but also may play a role in light shielding and buffering) shown in FIG. 4, and/or, at least one second bottom layer D is disposed between the connecting part 23 and the interlayer part 11 (for example, the protecting layer 3 shown in FIG. 4), thereby satisfying the designing requirements on some display modules 100. It should be noted that the thickness H1 of the interlayer part 11 may be decided according to the height H2 of the supporting part 12 in the first direction F1, the total thickness H1 of all of the first bottom layers C and the total thickness H2 of all of the second bottom layers D.

In some embodiments, as shown in FIGS. 4 and 5, the end in the first direction F1 of the supporting part 12 that is close to the non-bending part 21 is a first end 122, the end in the first direction F1 of the supporting part 12 that is close to the connecting part 23 is a second end 123, the surface of the side of the interlayer part 11 that is close to the non-bending part 21 is a first surface 112, the first surface 112 is located on the side of the first end 122 that is close to the second end 123 in the first direction F1, the surface of the side of the interlayer part 11 that is close to the connecting part 23 is a second surface 113, and the second surface 113 is located on the side of the second end 123 that is close to the first end 122 in the first direction F1. For example, in the example shown in FIG. 5, the first surface 112 is lower than the first end 122, and the second surface 113 is higher than the second end 123. Accordingly, at least one first bottom layer C may be disposed between the non-bending part 21 and the interlayer part 11, and at the same time at least one second bottom layer D is disposed between the connecting part 23 and the interlayer part 11, thereby satisfying the designing requirements on some display modules 100.

In some embodiments of the present application, as shown in FIGS. 4 and 5, in the first direction F1, the center of the interlayer part 11 is deviated from the center of the supporting part 12. In other words, there is a certain spacing between the center of the interlayer part 11 and the center of the supporting part 12 in the first direction F1. In other words, the end in the first direction F1 of the supporting part 12 that is close to the non-bending part 21 is a first end 122, the end in the first direction F1 of the supporting part 12 that is close to the connecting part 23 is a second end 123, and, in the first direction F1, the distance H4 between the first surface 112 of the interlayer part 11 and the first end 122 of the supporting part 12 is not equal to the distance H3 between the second surface 113 of the interlayer part 11 and the second end 123 of the supporting part 12, i.e., H4≠H3. Accordingly, the requirement that the total thickness H1 of all of the first bottom layers C and the total thickness H2 of all of the second bottom layers D are unequal may be satisfied.

In some embodiments of the present application, as shown in FIGS. 4 and 5, the end in the first direction F1 of the supporting part 12 that is close to the non-bending part 21 is a first end 122, the end in the first direction F1 of the supporting part 12 that is close to the connecting part 23 is a second end 123, and, in the first direction F1, the distance H4 between the interlayer part 11 and the first end 122 of the supporting part 12 is greater than the distance H3 between the interlayer part 11 and the second end 123 of the supporting part 12, i.e., H4>H3. Accordingly, the requirement that the total thickness H1 of all of the first bottom layers C is greater than the total thickness H2 of all of the second bottom layers D may be satisfied, and, in this case, more and/or thicker first bottom layers C may be disposed between the interlayer part 11 and the non-bending part 21. Certainly, the present application is not limited to what is described above, and, in other embodiments of the present application, optionally H4<H3, or H4=H3, which may satisfy different practical requirements.

It can be understood that, when the adhesive layers for adhesive bonding are ignored, H1+H3+H4=H2, wherein H4 may be equal to the total thickness H1 of all of the first bottom layers C, and H3 may be equal to the total thickness H2 of all of the second bottom layers D. In some embodiments, H1 is greater than or equal to the sum of the thickness of the protecting layer 3 and the thickness of the heat dissipating layer 4, and H2 is greater than or equal to the thickness of the protecting layer 3. For example, the thickness of the protecting layer 3 may be 0.04 mm-0.09 mm, and the thickness of the heat dissipating layer 4 may be 0.1 mm-0.5 mm.

In some embodiments of the present application, as shown in FIGS. 4 and 5, the end in the first direction F1 of the supporting part 12 that is close to the non-bending part 21 is a first end 122, the end in the first direction F1 of the supporting part 12 that is close to the connecting part 23 is a second end 123, and both of the first end 122 and the second end 123 are a smooth curved face. That may prevent stress concentration caused by the first end 122 at the corresponding position of the bent display panel 2, and prevent stress concentration caused by the second end 123 at the corresponding position of the bent display panel 2, thereby protecting the display panel 2 from being damaged.

In some embodiments of the present application, as shown in FIG. 6, the interlayer part 11 includes a setting side edge 111 extending in a second direction F2, the supporting part 12 is connected to the setting side edge 111, and the supporting part 12 also extends in the second direction F2. Accordingly, the supporting member 1 has a simple structure, and is easy to process. For example, in some particular embodiments, as shown in FIG. 6, the two ends of the supporting part 12 in the second direction F2 align with the two ends of the setting side edge 111 in the second direction F2. That may ensure that the supporting part 12 has a higher length in the second direction F2, to more reliably and effectively perform bending shape limiting and supporting protection to the bending part 22 of the display panel 2.

Certainly, the present application is not limited to what is described above, and, in other embodiments of the present application, the length of the supporting part 12 in the second direction F2 may also be slightly less than the length of the setting side edge 111 in the second direction F2, or the supporting part 12 may also be a plurality of supporting parts 12 that are separately and evenly distributed in the second direction F2, which may also perform bending shape limiting and supporting protection to the bending part 22 of the display panel 2 to a certain extent.

In some embodiments of the present application, as shown in FIGS. 5 and 6, the supporting curved face 121 is a circular-arc cylindrical face. Accordingly, the bending part 22 may be a circular-arc cylindrical face after bent, thereby satisfying the designing requirements on some display modules 100. Certainly, the present application is not limited to what is described above, and, in other embodiments of the present application, according to different designing requirements on the display module 100, the supporting curved face 121 may also be configured as other curved faces such as a paraboloidal curved face and an elliptical curved face, which is not limited herein.

In some embodiments of the present application, as shown in FIGS. 5 and 6, when the supporting curved face 121 is a circular-arc cylindrical face, the supporting part 12 may be overall of a semi-cylinder shape, and at the same time the interlayer part 11 is of a shape of a constant-thickness flat-plate. For example, as shown in FIGS. 5 and 6, the supporting part 12 further includes a first connecting face 124 and a second connecting face 125. The first connecting face 124 is used to connect the first surface 112 of the interlayer part 11 and the first end 122 of the supporting part 12, and the first connecting face 124 is parallel to the thickness direction of the interlayer part 11. The second connecting face 125 is used to connect the second surface 113 of the interlayer part 11 and the second end 123 of the supporting part 12, and the second connecting face 125 is parallel to the thickness direction of the interlayer part 11. Accordingly, the supporting curved face 121 may be close to the interlayer part 11, whereby the display panel 2 may be supported by the supporting member 1 to a larger extent.

Moreover, it should be noted that the “semi-cylinder shape” as used above should be comprehended broadly; in other words, the edges of the semi-cylinder shape may be rounded. For example, in the example shown in FIGS. 5 and 6, the supporting part 12 may further include a first transition curved face 126 and a second transition curved face 127. The first transition curved face 126 smoothly connects the first connecting face 124 and the first surface 112, and the second transition curved face 127 smoothly connects the second connecting face 125 and the second surface 113, which may increase the structural strength of the supporting member 1, to prevent the hidden danger in damage of the supporting member 1 due to local stress concentration.

Certainly, the present application is not limited to what is described above, and, in other embodiments of the present application, when the supporting curved face 121 is a circular-arc cylindrical face, the supporting part 12 may also be a sector-shaped cylinder and so on overall. Moreover, in some other embodiments, the interlayer part 11 may also be of a shape of a flat plate of a nonconstant thickness and so on, which is not discussed further herein.

In some embodiments of the present application, as shown in FIGS. 3 and 4, adhesive layers 13 are disposed on the two sides of the interlayer part 11 in the thickness direction of the interlayer part 11. Accordingly, in the bending process, the adhesive layers 13 on the two sides of the interlayer part 11 may be used to realize adhesive bonding. For example, in the example shown in FIG. 4, the adhesive layer 13 on the front face of the interlayer part 11 may be adhesively bonded to the first bottom layer C, and the adhesive layer 13 on the back face of the interlayer part 11 may be adhesively bonded to the second bottom layer D, which may reduce the difficulty in the processing. Moreover, it should be noted that, according to different practical situations, the supporting curved face 121 may be provided with the adhesive layers 13, and may also not be provided with the adhesive layers 13, which is required to be configured according to particular situations, and is not limited herein.

The display module 100 and its bending process steps according to a particular embodiment of the present application will be described briefly below.

As shown in FIGS. 3 and 4, firstly, the protecting layer 3 is adhesively bonded to the back side of the display panel 2. The protecting layer 3 may be located on the back sides of the non-bending part 21 and the connecting part 23, but avoid the back side of the bending part 22. Subsequently, the connecting part 23 is connected to the circuit components. Subsequently, a protecting adhesive 6 is disposed on the front side of the bending part 22. Subsequently, a cover plate (not shown in the figures) is disposed on the front side of the non-bending part 21. Subsequently, the heat dissipating layer 4 is disposed on the back side of the protecting layer 3 on the back side of the non-bending part 21. Subsequently, the supporting member 1 is disposed on the back side of the heat dissipating layer 4. Subsequently, the bending part 22 is bent, during the bending, the inner surface of the bending part 22 may be ensured to adhere to the supporting curved face 121, till the connecting part 23 is turned over to the back side of the interlayer part 11, and the protecting layer 3 on the back side of the connecting part 23 is adhesively bonded to the interlayer part 11.

It should be noted that the circuit components particularly referred to in the above-described “the connecting part 23 is connected to the circuit components” and the corresponding connection modes are not limited. For example, optionally, as shown in FIG. 3, the connecting part 23 is connected to a Flip-Chip thin film 7 having an IC chip, and the Flip-Chip thin film 7 is connected to a flexible circuit board 8. As another example, optionally, as shown in FIG. 8, the connecting part 23 is provided with an IC chip, and the connecting part 23 is directly connected to a flexible circuit board 8. Moreover, it should be noted that the “front side” as used herein refers to the displaying side of the display panel 2, and the “back side” refers to the non-displaying side of the display panel 2.

It should be noted that that “the inner surface of the bending part 22 adheres to the supporting curved face 121” as used herein refers to that the inner surface of the bending part 22 at least partially contacts the supporting curved face 121 without a gap, it is not required that the whole of the inner surface of the bending part 22 must contact the supporting curved face 121 without a gap, and it is not required that there is an adhesive between the inner surface of the bending part 22 and the supporting curved face 121, wherein there may be an adhesive, and there may also not be an adhesive.

In some embodiments, the first end 122 configured to be a smooth curved face and one end of the supporting curved face 121 may be directly connected (for example, as shown in FIG. 5) or indirectly connected by a first extended plane 128 (as shown in FIG. 9), and the second end 123 configured to be a smooth curved face and the other end of the supporting curved face 121 may be directly connected (for example, as shown in FIG. 5) or indirectly connected by a second extended plane 129 (as shown in FIG. 9). Whether it is required to dispose the first extended plane 128 and the second extended plane 129 may be calculated by using the following formula.

As shown in FIGS. 3 and 9, the width of the supporting part 12 is defined as W1, the radius of the supporting curved face 121 is defined as R, the position precision of the protecting layer 3 is defined as a, the adhesion position precision of the supporting member 1 is defined as b, and the width of the protecting layer 3 at the position avoiding the back side of the bending part 22 is defined as W0, wherein W0≥2a+2b+πR, and W1=R+(W0-2a-2b-πR)/2. Accordingly, it may be seen that when W0-2a-2b-πR=0, w1=R, and accordingly it is not required to dispose the first extended plane 128 and the second extended plane 129. When W0-2a-2b-πR>0, w1>R, and the first extended plane 128 and the second extended plane 129 may be disposed. Moreover, the width of the interlayer part 11 is defined as W2, wherein the value range of W2 is not limited, and, for example, may be 3 mm-5 mm and so on.

Moreover, it should be noted that the structure and the shape of the supporting member 1 according to the embodiments of the present application are different from the structure of the spacer A3 in the related art. For example, the spacer in the related art is in the form of a flat plate. A plurality of spacers may be curled into a reel, and transported, subsequently the spacer reel is deployed, and each of the spacers is sequentially taken out for material feeding. However, the spacer A3 according to the embodiments of the present application is not in the form of a flat plate, and cannot be curled into a reel. Therefore, the present application has inventively proposed that a tray may be used for material feeding and discharging of the supporting member 1. In other words, all of a plurality of produced supporting members 1 may be placed in a plurality of compartments of a tray and transported, and, in usage, a matching suitable adhering mechanism feeds the supporting member 1, wherein the adhering mechanism may include a vacuum attracting device, a mechanical arm and so on. Moreover, it should be noted that the material and the processing method of the supporting member 1 are not limited. It may be a non-metal piece, and may also be a metal piece. For example, it may particularly be sponge, a rubber material and so on. It may be transparent, and may also be non-transparent, which may be particularly configured according to different situations.

In conclusion, in the display module 100 according to at least one embodiment of the present application, by optimized designing of the supporting member 1 used in the bending of OLED products, the supporting member 1 is configured as the appearance shown in FIG. 6; in other words, the surface of the side of the supporting member 1 that is close to the bending part 22 is configured as the appearance of the eccentric circular arc satisfying the requirement on the radius. Accordingly, it may be ensured by using the circular-arc appearance of the supporting part 12 that the bending path of the bending part 22 of the display panel 2 may be realized by adhering to the circular-arc shape of the supporting part 12, whereby the bending part 22 obtains the circular-arc appearance the same as that of the bending path. At the same time, the supporting part 12 may serve to support and protect the bending part 22, which reduces the risk in the coating of the protecting adhesive 6 and the process of the bending path and the risk in product failure by the effect of an external force.

A display device 1000 according to an embodiment of the present application will be described below.

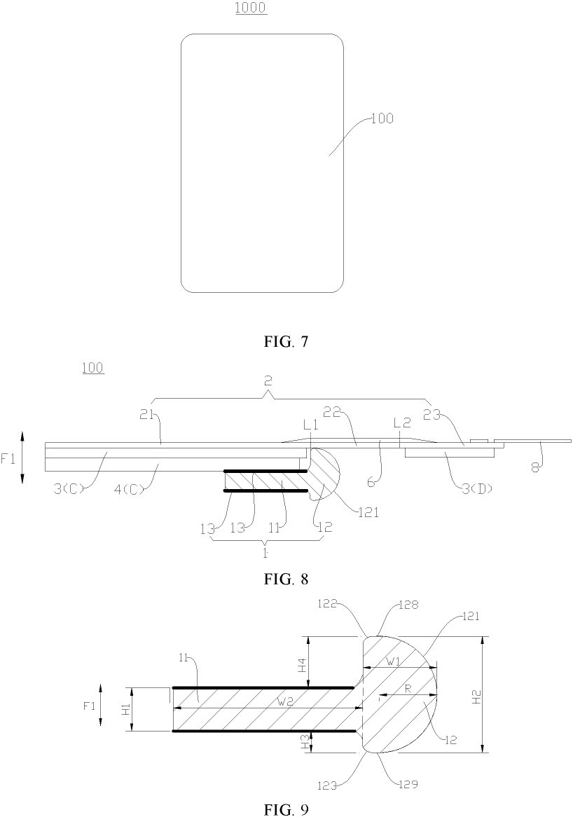

As shown in FIG. 7, the display device 1000 according to an embodiment of the present application may include the display module 100 according to any one of the above embodiments. By disposing the display module 100, the overall difficulty in processing the display device 1000 may be reduced, and the overall quality of the display module 100 may be improved. Moreover, in some embodiments of the present application, the display device 1000 may further include a touch panel disposed on the display module 100 and so on.

Moreover, it should be noted that the particular type of the display device 1000 according to the embodiments of the present application is not limited. For example, it may be a narrow-border-frame or border-frame-less display device, and, more particularly, may be any products or components that have the function of displaying, such as a mobile phone, a monitor, a tablet personal computer, a television set, a notebook computer, a digital photo frame, a navigator and a wearable device. Moreover, the other components and operations of the display device 1000 according to the embodiments of the present disclosure, when the particular type of the display device 1000 has been determined, are known to a person skilled in the art, and are not described in detail herein.

In the description of the present application, the description referring to the terms “an embodiment”, “some embodiments”, “example”, “particular example” or “some examples” and so on means that particular features, structures, materials or characteristics described with reference to the embodiment or example are included in at least one of the embodiments or examples of the present application. In the description, the illustrative expressions of the above terms do not necessarily relate to the same embodiment or example. Furthermore, the described particular features, structures, materials or characteristics may be combined in one or more embodiments or examples in a suitable form. Furthermore, subject to avoiding contradiction, a person skilled in the art may combine different embodiments or examples described in the description and the features of the different embodiments or examples.

Although the embodiments of the present application have already been illustrated and described, a person skilled in the art may understand that those embodiments may have various alterations, modifications, substitutions and variations without departing from the principle and the spirit of the present application, and the scope of the present application is defined by the claims and the equivalents thereof.

1. A display module, wherein the display module comprises:
a supporting member, wherein the supporting member comprises an interlayer part and a supporting part, the supporting part is connected to a side edge of the interlayer part, a surface of one side of the supporting part that is away from the interlayer part is a supporting curved face, and the supporting curved face protrudes in a direction away from the interlayer part; and
a display panel, wherein the display panel comprises a non-bending part, a bending part and a connecting part, the bending part connects the non-bending part and the connecting part, and after the display panel has been bent, the non-bending part and the connecting part are located on two sides of the interlayer part in a thickness direction of the interlayer part, the bending part supports one side of the supporting part that is away from the interlayer part, and an inner surface of the bending part adheres to the supporting curved face.

2. The display module according to claim 1, wherein the thickness direction of the interlayer part is a first direction, and a height H2 of the supporting part in the first direction is greater than a thickness H1 of the interlayer part.

3. The display module according to claim 2, wherein one end among two ends in the first direction of the supporting part that is close to the non-bending part is a first end, one end that is close to the connecting part is a second end, a surface of one side of surfaces of two sides in the thickness direction of the interlayer part that is close to the non-bending part is a first surface, a surface of one side that is close to the connecting part is a second surface, and in the first direction, the first surface is located on one side of the first end that is close to the second end, and the second surface is located on one side of the second end that is close to the first end.

4. The display module according to claim 3, wherein in the first direction, a distance H4 between the first surface and the first end is greater than a distance H3 between the second surface and the second end.

5. The display module according to claim 3, wherein a surface of the first end is a smooth curved face, and a surface of the second end is a smooth curved face.

6. The display module according to claim 1, wherein the interlayer part comprises a setting side edge extending in a second direction, the supporting part is connected to the setting side edge, and the supporting part also extends in the second direction.

7. The display module according to claim 6, wherein two ends of the supporting part in the second direction align with two ends of the setting side edge in the second direction.

8. The display module according to claim 1, wherein the supporting curved face is a circular-arc cylindrical face.

9. The display module according to claim 8, wherein the supporting part is of a semi-cylinder shape, and the interlayer part is of a shape of a constant-thickness flat-plate.

10. The display module according to claim 1, wherein adhesive layers are disposed on two sides of the interlayer part in the thickness direction of the interlayer part.

11. A display device, wherein the display device comprises the display module according to claim 1.

12. The display device according to claim 11, wherein the thickness direction of the interlayer part is a first direction, and a height H2 of the supporting part in the first direction is greater than a thickness H1 of the interlayer part.

13. The display device according to claim 12, wherein one end among two ends in the first direction of the supporting part that is close to the non-bending part is a first end, one end that is close to the connecting part is a second end, a surface of one side of surfaces of two sides in the thickness direction of the interlayer part that is close to the non-bending part is a first surface, a surface of one side that is close to the connecting part is a second surface, and in the first direction, the first surface is located on one side of the first end that is close to the second end, and the second surface is located on one side of the second end that is close to the first end.

14. The display device according to claim 13, wherein in the first direction, a distance H4 between the first surface and the first end is greater than a distance H3 between the second surface and the second end.

15. The display device according to claim 13, wherein a surface of the first end is a smooth curved face, and a surface of the second end is a smooth curved face.

16. The display device according to claim 11, wherein the interlayer part comprises a setting side edge extending in a second direction, the supporting part is connected to the setting side edge, and the supporting part also extends in the second direction.

17. The display device according to claim 16, wherein two ends of the supporting part in the second direction align with two ends of the setting side edge in the second direction.

18. The display device according to claim 11, wherein the supporting curved face is a circular-arc cylindrical face.

19. The display device according to claim 18, wherein the supporting part is of a semi-cylinder shape, and the interlayer part is of a shape of a constant-thickness flat-plate.

20. The display device according to claim 11, wherein adhesive layers are disposed on two sides of the interlayer part in the thickness direction of the interlayer part.
